(19) United States
(12) Patent Application Publication
(10) Pub. No.: US 2008/0086895 A1
(43) Pub. Date: Apr. 17, 2008

(54) Utility knife with integrated hole punch

(76) Inventor: Thomas Jerald Parks, Springdale, AR (US)

Correspondence Address: HENRY LAW FIRM, P.O. BOX 1105, FAYETTEVILLE, AR, 72702, US

(21) Appl. No.: 11/550,025

(22) Filed: Oct. 17, 2006

(51) Int. Cl. B26B 3/06; F41B 13/02

(52) U.S. Cl. 30/156; 30/160

(57) ABSTRACT

A utility knife in accordance with the present invention combines a cutting tool and a hole punch into a single compact, efficient tool. The utility knife includes a recess into which the cutting blade is retracted and another recess to store a hole punch. The hole punch pivots from one end the body so that a piece of material to be punched can be placed between the hole punch and the body. The hole punch is pivoted towards the body to punch through the material. The punch mechanism pushes confetti from the material into a confetti storage cavity within the body. A user can open the confetti storage door to discard the confetti stored within the body. The present invention also allows a user to store extra cutting blades within a recess in the hole punch arm.

### CROSS REFERENCES

None.

### GOVERNMENTAL RIGHTS

None.

### BACKGROUND OF THE INVENTION

The present invention pertains generally to a multipurpose handheld tool and more particularly to a utility knife with an integrated hole punch that is easily operated using one hand.

Retail store employees receive shipments, open boxes, sort through merchandise, and stock shelves and displays. As with most jobs, speed and efficiency are important considerations. Stock must be shelved quickly and neatly to provide sufficient turnover and income, and in the case of food products, speed may reduce the risk of spoliation. A tool commonly used by retail store employees is a cutting implement, usually referred to as a utility knife. A typical utility knife has a retractable blade and is used to cut shipping containers and packaging materials such as shrink-wrap, tape, and boxes to access the contents of the containers.

One of the disadvantages of a typical utility knife is that the user can only utilize the tool as a cutting instrument. In the retail setting, a typical store provides hanging racks that accept pegs of varying lengths on which merchandise can be hung for display. Merchandise is usually shipped with a hole punched in the merchandise packaging to allow for display on a peg of a hanging rack. However, in some situations, the hole is defective or does not exist, and a store employee cannot properly display the merchandise. The solution of the prior art was to have the store employee carry a hole punch in addition to a utility knife so the employee could punch a hole in the merchandise packaging and display the merchandise properly.

Some examples of multipurpose tools are shown in U.S. Pat. No. 4,783,867 (“the '867 patent”), U.S. Pat. No. 6,460,433 (“the '433 patent”), U.S. Pat. No. 6,493,893 (“the '893 patent”), and U.S. Pub. No. US 2002/0064040 (“the '040 application”). The present invention improves upon the known art as more fully described, below.

The '867 patent discloses a multi-functional tool combination that has a top and bottom casing and guiding plate which forms a compartment for the arrangement of a pair of scissors, a measuring tape, a stapler, a paper punch, a pencil sharpener, a blade, and other functional features. Applicant's invention represents an advance in the art above the '867 patent by providing users with an easy to operate hole punch that can be used without time-consuming manipulation of the blade. In contrast, the tool disclosed in the '867 patent requires substantial manipulation to place the device in a position in which the cutting blade can be used as opposed to a position in which the hole punch can be used. The present invention further advances upon the tool contemplated by the '867 patent by allowing far more flexibility for the placement of a hole with the hole punch. This feature enables a store employee to better adjust the placement of the hole to a desired position on the article of goods. In addition, the present invention allows for a simpler design, which decreases manufacturing costs relative to the tool contemplated by the '867 patent.

Like the '867 patent, the '893 patent discloses a handheld implement that contains, inter alia, a stapler and/or a hole punch. The present invention improves upon the '893 patent by greatly simplifying the complexity in design and by permitting users to store additional cutting blades internally to replace a used cutting blade. The present invention also advances upon the apparatus disclosed in the '893 patent by providing a recess within the body for storage of both the hole punch and confetti, which provides for a more compact design.

The '040 application discloses a hole punch and a stapler that are selectively engaged and stored within a housing in addition to a myriad of other features, including scissors, a laser pointer, a screwdriver, knife and a miniature implement. The punch of the '040 application is limited in application to punching holes near the edges of thin sheets of paper, where the present invention is more flexible as to location and types of materials that may be punched. Further, the complexity of the '040 application will invariably drive manufacturing costs to such a level that the price of such a device is not competitive with the present invention. Accordingly, the '040 application discloses a device that is not commercially adaptive to the market for which the present application is situated. The present invention greatly reduces the complexity revealed by the '040 application by integrating the hole punch with the body of the utility knife in an elegant manner, and this simplicity reduces manufacturing costs and allows the present invention to be sold at more competitive prices.

It is an object of the present invention to provide a utility knife with an integrated hole punch, which offers substantially increased functionality in a single unit. The present invention allows a worker to cut open a shipping container and punch a new hole in any merchandise packaging in order to properly display the item on a hanging rack. The present invention allows store employees to use one instrument to perform multiple functions, thus improving their work efficiency by reducing the time associated with stocking merchandise with damaged packaging.

It is a further object of the present invention to provide a utility knife with integrated hole punch in which the hole punch may be used without substantial manipulation of the blade.

It is a further object of the present invention to provide a hole punch that allows for great flexibility in the placement of a hole in a wide range of packaging materials.

It is a further object of the present invention to provide an internal storage space for confetti to avoid littering storeroom floors.

It is a further object of the present invention to improve upon traditional utility knives by adding the functionality of a hole punch.

It is yet another object of the present invention to provide users with a single tool for cutting open boxes and punching holes in articles of goods on display on display racks.

It is yet another object of the present invention to greatly increase stocking efficiency and reduce the occurrence of inventory loss or waste.

### BRIEF SUMMARY OF THE INVENTION

The multipurpose utility knife of the present invention provides a utility knife with an integrated hole punch and comprises a body, a cutting blade, a spare blade holder, a hole punch arm, a hole punch recess, a hole punch bit, a confetti storage cavity, a confetti removal door, and a spare blade holder. The present invention may be constructed from various rigid structural materials such as plastic, metal, or epoxy resin. The present invention's compact size means that it may be comfortably carried in a pocket for easy access.

The body of the device disclosed herein is designed to permit the cutting blade to be stored in a recess for safety reasons. The present invention is also designed to allow storage of at least one spare cutting blade. To use the utility knife feature, a user depresses a blade slide button and selectively adjusts the blade slide button longitudinally, along the lengthwise axis of the housing. By advancing the blade slide button, the user protracts or retracts the cutting blade from the body. Once a user protracts the blade, the user can open merchandise packaging to access the contents. If the cutting blade is dull, a user may access a spare cutting blade stored within an arm pivotally attached to the body of the present invention and replace the dull blade with a new, sharp blade. When the arm is pivoted to the open position, a recess within the arm for storing a plurality of spare blades is exposed.

The present invention also allows a store employee to easily make a new display hanging hole in product packaging to allow a product with a defective or torn display hole to be hung from display pegs. To make a display hole with the present invention, a user selectively disables an optional hole punch lock and pivots a hole punch arm from a closed position to an open position. A user then positions the desired material within a receiving area defined between the hole punch arm and the body when the hole punch arm is pivoted to the open position. The user then applies sufficient pressure to the hole punch arm to complete a punch through the material. The present invention then forces the resulting confetti, i.e., the piece of material that is punched from the article, through the hole punch recess into a confetti storage cavity.

After a user has completed the repair of the article, the user may return the hole punch arm back to the closed position. After returning the hole punch arm to the closed position, the user may engage the hole punch lock to keep the hole punch arm in the closed position.

These and other advantages will become apparent from the following detailed description which, when viewed in light of the accompanying drawings, disclose the embodiments of the present invention.

### BRIEF DESCRIPTION OF THE DRAWINGS

FIG. 1 is a front elevational view of the present invention.

FIG. 2 is a front elevational view of the present invention with the hole punch arm adjusted to an open position.

FIG. 3 is a front elevational view of the present invention with the cutting blade adjusted to a cutting position.

FIG. 4 is a perspective view of the present invention with the hole punch arm adjusted to an open position.

FIG. 5 is a back elevational view with the hole punch arm adjusted to an open position and the confetti removal door adjusted to an open position.

FIG. 6 is an exploded view of the present invention.

### DETAILED DESCRIPTION OF THE INVENTION

The present invention discloses a utility knife that provides the heretofore unknown features of an integrated hole punch mechanism and an internal confetti storage cavity. The inventor believes that the present invention will be useful to retail store and other employees who routinely carry both a utility knife and a hole punch.

Referring generally to the figures, a utility knife 2 includes a body 4 that has a cutting blade recess 14 for storing a cutting blade holder 6. The cutting blade holder 6 is secured to the inside of the body 4 to prevent the cutting blade holder 6 from moving inside the body. A cutting blade 10 placed into the cutting blade holder 6 and secured into a recess between the two halves of body 4. A cutting blade slot 8 in the body 4 allows the cutting blade 10 to be extended from the body or to be retracted into the body 4.

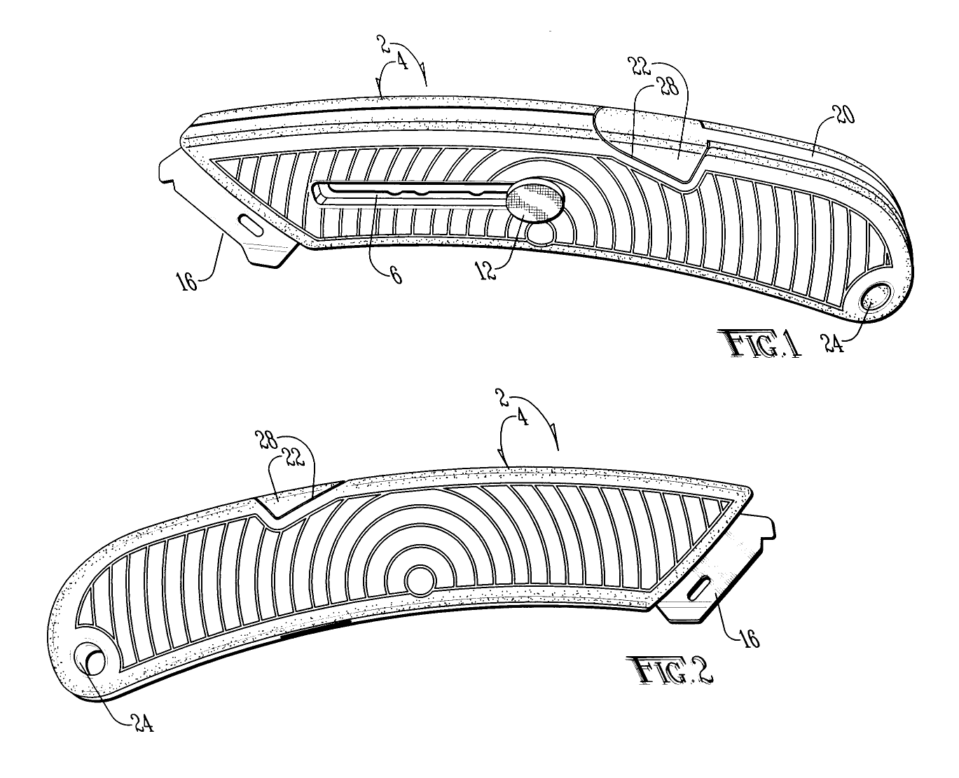

FIG. 1 shows an exemplary utility knife according to the present invention designed for a right-handed user. A left-handed knife is contemplated by the present invention and would be constructed essentially as a mirror image of the right-handed knife. The utility knife 2 includes an ergonomically designed body 4. The body 4 includes shallow grooves on both sides to provide a better grip for a user of the knife. As shown in FIG. 1, body 4 is designed with a curved configuration to fit more comfortably and securely in the hand. The curved surfaces of the present invention provide a body 4 that would naturally lie in the palm of an average user's hand. The utility knife 2 includes a blade guard 16 which also serves as a cutting guide that extends from the body 4. The blade guard acts as a guide to position the blade for cutting as the blade guard slides across the object that the user is attempting to cut.

The body 4 can be formed of materials, such as metal, plastic, and composites such as filled polymer resins and other combinations of materials. The surface can be treated to provide texture or coated with another material to improve the frictional resistance to improve comfort and to prevent slippage from the user's hand.

In FIG. 1, the utility knife 2 is in a safe storage condition with the cutting blade 10 fully retracted into the body 4. A blade slide button 12 extends outwardly through body 4 allowing the user to manipulate the blade slide button 12.

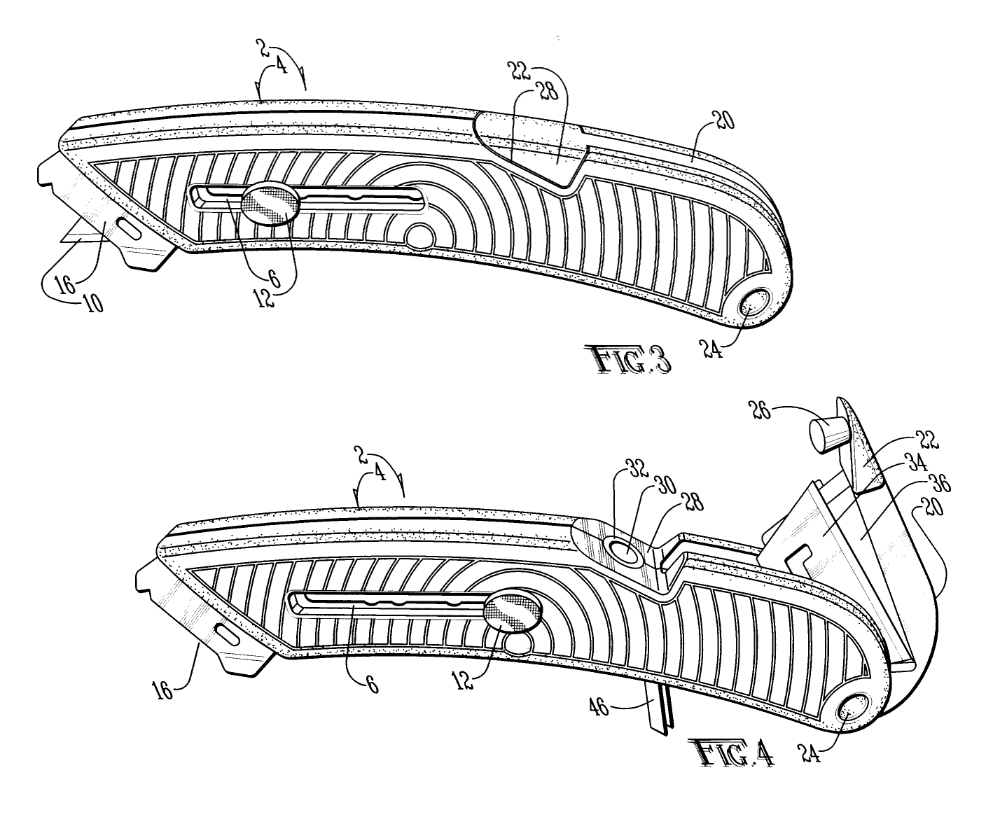

Referring to FIG. 2, the second side of the utility knife is similar to the first side of the utility knife as shown in FIG. 1. The second side of the utility knife encloses the cutting blade holder, so the blade slide button 12 of FIG. 1 is not exposed to a user.

FIG. 3 shows the utility knife in a configuration for cutting. In order to use the utility knife of the present invention, a user depresses the blade slide button 12 and move the blade slide button 12 longitudinally to cause the blade to protract from or retract into the present invention to a plurality of operating positions, including a retracted position, at least one cutting position, and a blade changing position. Optionally, the blade slide button 12 must be depressed into the body 4 to disengage the cutting blade lock to allow the cutting blade to be adjusted.

The present invention also allows a user to change cutting blades to prevent a user from being required to use a dull cutting blade, thus extending the useful life of the utility knife. To change the cutting blade, the user extends the cutting blade to expose the cutting blade holder 6. The user then removes the dull cutting blade and installs a new, sharp cutting blade.

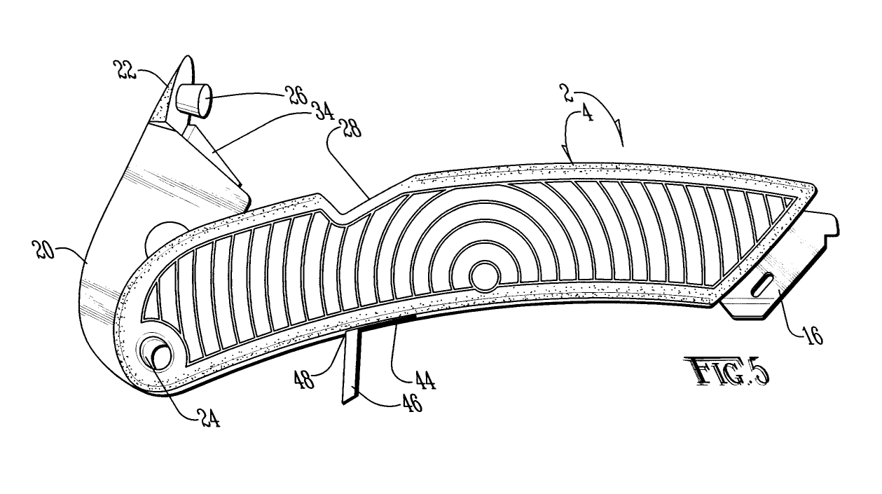

Turning now to FIG. 4, the utility knife 2 includes a hole punch arm 20 shown pivoted away from body 4 to an open position. The hole punch arm is pivotally attached to body 4 by a hole punch pivot 24. Spare blade holder 36 is recessed within hole punch arm 20 to receive a plurality of all-purpose utility blades. Optional retaining fingers (not shown) attached to the spare blade holder 36 prevent the spare cutting blades from inadvertently escaping spare blade holder 36 when hole punch arm 20 is pivoted away from body 4 to an open position. In another embodiment, the spare cutting blades are secured in the spare blade holder 36 by an L-shaped catch.

The design of the present invention prevents the hole punch arm 20 from unexpectedly pivoting from the closed position to the open position. In one embodiment, the present invention provides the user with a hole punch arm lock designed as an L-shaped catch that engages the hole punch arm with the body to prevent the hole punch arm from adjusting to an open position. In another embodiment, the present invention provides the user with a hole punch arm lock that frictionally engages the hole punch arm 20 with body 4 to prevent the hole punch arm 20 from adjusting to an open position without user manipulation.

FIG. 4 also shows the hole punch mechanism of the present invention. To operate the hole punch, a user disengages the hole punch arm lock by manipulating the hole punch arm lock. After the hole punch arm lock is disengaged, the hole punch arm spring biases the hole punch arm into an open position. A user then inserts the material to be punched between the hole punch arm 20 and hole punch base 28. As seen in FIG. 4, hole punch base 28 provides the user a flat area to place the material to be punched. After a user places the material on hole punch base 28, the user pivots the hole punch arm 20 into the closed position; this movement causes a hole punch bit 26 to punch through the material and into the hole punch recess 30. A user then adjusts hole punch arm 20 to an open position to remove the material from the hole punch base and insert new material to be punched. When a user finishes punching holes, the user may then pivot the hole punch arm 20 to the closed position and engage the hole punch arm lock.

In the preferred embodiment, the hole punch bit 26 is integrated as one piece with the hole punch arm, although the hold punch bit can be secured by other means known in the art. Also in the preferred embodiment, the hole punch bit 26 has a metal cutting piece for piercing the material to be punched.

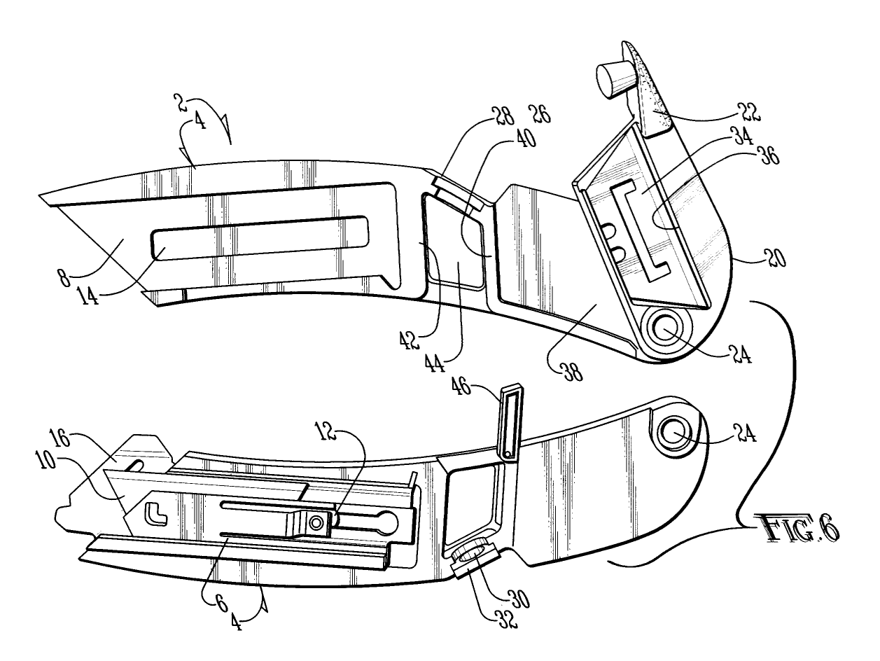

Turning now to FIG. 5, the present invention provides for a disposal system for capturing, storing, and expunging the confetti that results from using the integrated hole punch of the present invention. When a user punches material with hole punch bit 26, hole punch bit 26 cuts through the material and then enters hole punch recess 30. Hole punch bit 26 pushes confetti through hole punch recess 30 and into confetti storage cavity 44. Confetti removal door 46, located flush with and attached to body 4, prevents confetti from littering the area surrounding the user when the confetti removal door 46 is closed. The confetti removal door 46 is frictionally engaged with body 4 to prevent the confetti removal door 46 from unexpectedly opening. The confetti removal door 46 is adjustable between an open and closed position. A user removes confetti from the utility knife 2 by opening confetti removal door 46, orienting the utility knife 2 such that the confetti removal door is pointed down, and gently shaking the utility knife 2.

FIG. 6 is an exploded view which demonstrates how the claimed features of the preferred embodiment are constructed. The utility knife 2 includes a hole punch recess 30 to transfer the confetti to the confetti storage cavity 44. In addition, the hole punch recess 30 stores the hole punch bit 26 when the hole punch arm 20 is in a closed position. The hole punch recess 30 is located on the outer surface of body 4 between body 4 and hole punch arm 20 aligned with the hole punch bit 26 as shown in FIG. 4. The hole punch recess 30 is located on body 4 to allow hole punch arm to be pivoted to a closed position that is flush with body 4. In order for the hole punch arm to be flush with body 4 when hole punch arm 20 is in the closed position, the hole punch bit 26 must be able to travel through the hole punch recess 30. In addition, the hole punch recess 30 is slightly larger than hole punch bit 26 to allow hole punch bit 26 to be stored inside of hole punch recess 30 when hole punch arm 20 is in the closed position. In one embodiment, the hole punch recess is surrounded by a metal piece, hole punch ring 32, to provide extra strength to the body to prevent damage to the present invention caused during hole punching functions.

Considering now more particularly FIG. 6, a rear recess 38 and a confetti storage cavity 44 are formed within the body 4. The rear recess 38 is cooperatively defined by a pair of spaced apart side walls of body 4 and is adapted to receive a hole punch arm 20 that includes a spare blade holder 36 recessed within the hole punch arm 20. The hole punch arm 20 is inserted into the rear recess 38 of body 4. The hole punch arm 20 is then pivotally coupled with body 4 to allow hole punch arm 20 to pivot to an open position and a closed position. As known in the art, the hole punch arm 20 may be attached by other means as well.

The hole punch recess 30 of the present invention transfers confetti from outside the body of the present invention to the confetti storage cavity 44. Referring to FIG. 6, the confetti storage cavity 44 is found within a recess of body 4. The confetti storage cavity 44 is separated from the main recess of body 4 by storage walls 40, 42 inside body 4. By separating confetti storage cavity 44, the present invention prevents confetti from interfering with the utility knife's main functions of cutting and punching holes.

In one embodiment, the confetti removal door 46 is pivotally attached to body 4 at confetti door pivot 48. In another embodiment, confetti removal door 46 is slideably attached to body 4 such that the confetti removal door slides open or closed. In another embodiment, the present invention employs a section of the hole punch arm as the confetti removal door. The hole punch arm 20 is adjusted to an open position that exposes confetti storage cavity 44. Once the confetti removal door has been opened, a user can remove confetti from confetti storage cavity 44.

Furthermore, in another embodiment, the present invention includes a spring attached to the inside of body 4 and the hole punch arm 20. The spring biases the hole punch arm into an open position to allow the present invention to be ready to accept material to be punched.

In another embodiment, the present invention does not contain a hole punch arm spring to bias the hole punch arm to an open position. To use this embodiment of the present invention, the user must manually adjust the hole punch arm to an open position. First, the user must disengage the hole punch arm lock, if the lock is present. The user then manually adjusts the hole punch arm 20 to an open position. The hole punch arm of the present invention provides the user with a hole punch finger 22 to assist the user in manipulating hole punch arm 20. After use, the user returns the hole punch arm 20 to a closed position and engages the hole punch arm lock or frictionally engages the hole punch arm 20 with the body to prevent the hole punch arm 20 from returning to an open position.

While the inventor has described above what he believes to be the preferred embodiments of the present invention, persons having ordinary skill in the art will recognize that other and additional changes may be made in conformance with the spirit of the invention and the inventor intends to claim all such changes as may fall within the scope of the invention.

I claim:

1. A utility knife with integrated hole punch, comprising:
a body;
a cutting blade slideably attached to the body;
a hole punch arm pivotally connected to the body such that the hole punch arm can be oriented in a closed position, where the hole punch arm is partially stored within a recess of the body, and an open position, where the hole punch arm is pivoted away from the body;
a hole punch bit coupled to the hole punch arm;
a hole punch recess located in the body through which the hole punch bit may travel; and
a confetti storage cavity located adjacent to the hole punch recess within the body.

2. The apparatus of claim 1, wherein the body is adapted to internally store the cutting blade.

3. The apparatus of claim 1, further comprising a cutting blade lock coupled with the cutting blade for preventing the cutting blade from protracting from the body unless the cutting blade lock is disengaged.

4. The apparatus of claim 1, wherein the body is adapted to internally store the cutting blade and which further comprises a cutting blade lock coupled with the cutting blade for preventing the cutting blade from retracting into the body unless the cutting blade lock is disengaged.

5. The apparatus of claim 1, wherein the hole punch arm is adapted to store a plurality of spare cutting blades.

6. The apparatus of claim 1, wherein the hole punch arm is adapted to store spare cutting blades and which further comprises retaining fingers coupled with the spare blade storage for storing a plurality of spare cutting blades.

7. The apparatus of claim 1, further comprising a hole punch arm lock coupled with the body to engage the hole punch arm to prevent the hole punch arm from adjusting from the closed position to the open position.

8. The apparatus of claim 1, further comprising a confetti removal door coupled with the body capable of enclosing the confetti storage cavity.

9. The apparatus of claim 1, further comprising a spring that communicates with the hole punch arm and the body which biases the hole punch arm into an open position.
